(19) United States
(12) Patent Application Publication
(10) Pub. No.: US 2009/0030609 A1
(43) Pub. Date: Jan. 29, 2009

(54) System and Method for Proactive Agenda Management

(75) Inventors: Mark ORTTUNG, Menlo Park, CA (US); Timothy A. MILLER, San Francisco, CA (US); Brian GODDEN, Los Gatos, CA (US); Patrick NEWMAN, Palo Alto, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: REARDEN COMMERCE, INC., Foster City, CA (US)

(21) Appl. No.: 11/829,816

(22) Filed: Jul. 27, 2007

(51) Int. Cl. G01C 21/02; G01C 21/00

(52) U.S. Cl. 701/213; 701/207

(57) ABSTRACT

One embodiment provides a method, that may be implemented on a system for identifying a schedule of events for a first user, the schedule of events comprising of one or more of appointments and travel arrangements; identifying a current location of the first user relative to a scheduled location of the first user based on the schedule of events; in response to a divergence between a current location and a scheduled location, projecting a latency for one or more remaining scheduled events; and in response to the projected latency meeting or exceeding an identified amount, identifying priorities among remaining scheduled events and rescheduling one or more remaining scheduled events based on the identified priorities.

### BACKGROUND OF THE INVENTION

Often, for various reasons, some within and some beyond the control of a traveler or a business person, appointments cannot be kept on time. For example, a traveler may be victim of transportation system delays. In other cases, a delay at an appointment may be due to a meeting that is important and cannot be cut short running past its anticipated ending time. In any case, appointments and meeting times are often wasted when one party does not attend, resulting in, at the least, annoyance and inconvenience for the other attendee(s), and sometimes resulting in more serious damaging consequences.

What is clearly needed is system and method that proactively recognizes the potential for such a problem, or recognizes early-on that such a problem is arising, and notifies the attendees of the meeting at risk of either a delay or of the need to reschedule. What is further needed is a system and method for rescheduling meetings that seem at risk of being delayed or missed and for reorganizing and rebooking facilities and services attendant on the meeting as needed.

### DESCRIPTION OF THE EMBODIMENTS

The disclosure is illustrated by way of example and not limitation in the figures of the accompanying drawings in which like references indicate similar elements

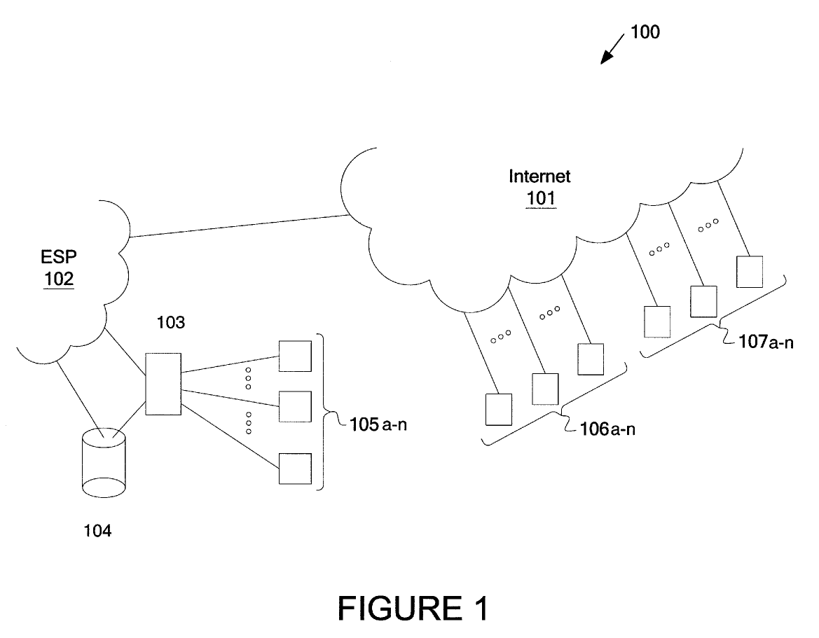

FIG. 1 shows an exemplary overview of a system 100 according to one embodiment of the current invention;

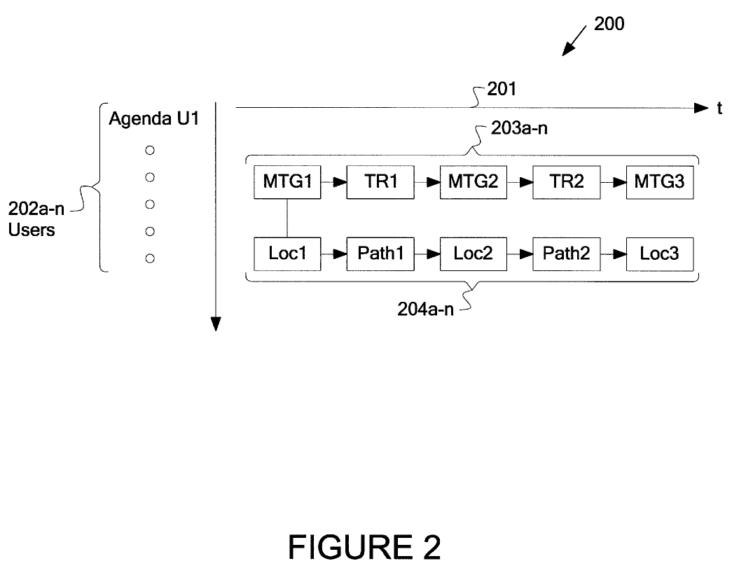

FIG. 2 shows an exemplary overview of a calendar system 200, such as would reside in a PIM or PIM database of many users 202a-n;

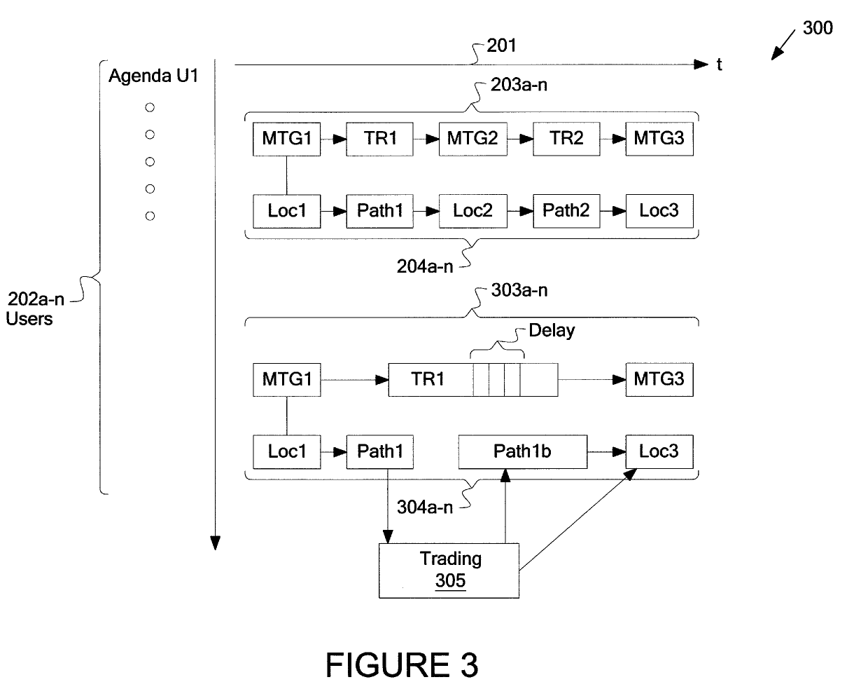

FIG. 3 shows an exemplary calendar system 300 accounting for a variation in actual time of agenda U1 of user 1 202a; and

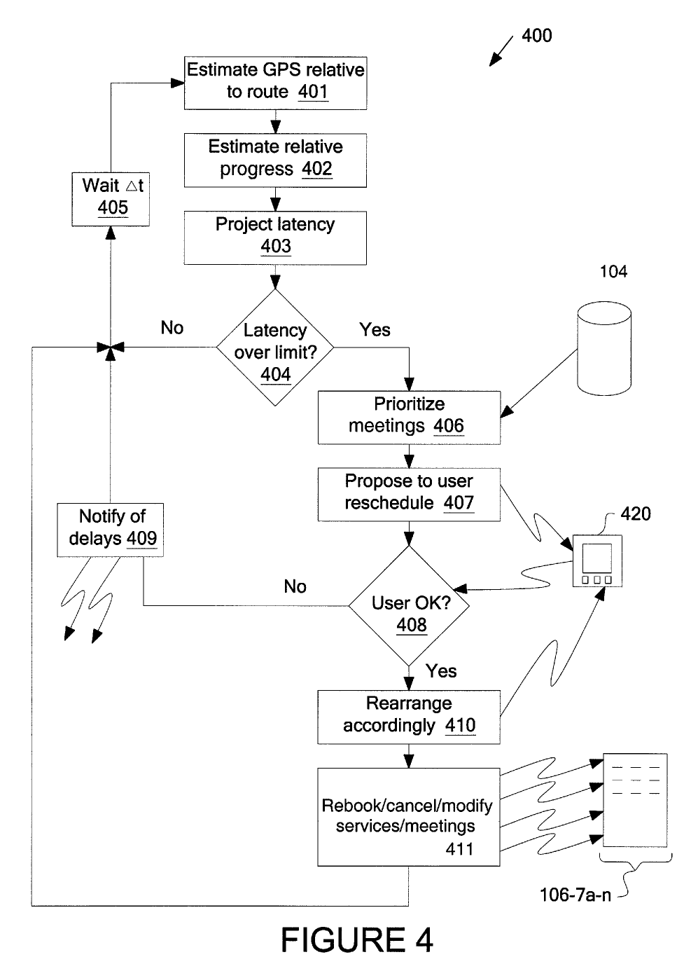

FIG. 4 shows an exemplary process 400 for tracking and rebooking events according to one embodiment of the present invention.

### SUMMARY

Some embodiments of the present invention are summarized in this section.

One embodiment provides a method, that may be implemented on a system for identifying a schedule of events for a first user, the schedule of events comprising of one or more of appointments and travel arrangements; identifying a current location of the first user relative to a scheduled location of the first user based on the schedule of events; in response to a divergence between a current location and a scheduled location, projecting a latency for one or more remaining scheduled events; and in response to the projected latency meeting or exceeding an identified amount, identifying priorities among remaining scheduled events and rescheduling one or more remaining scheduled events based on the identified priorities.

The present disclosure includes methods and apparatuses which perform these methods, including processing systems which perform these methods, and computer readable media which when executed on processing systems cause the systems to perform these methods.

Other features of the present invention will be apparent from the accompanying drawings and from the detailed description which follows.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

FIG. 1 shows an exemplary overview of a system 100 according to one embodiment of the current invention. An electronic services portal ESP 102 connects to a server 103 and a data repository 104. The server hosts software instances 105a-n of the present invention, which, depending on the implementation of the system, may be one, several, or many instances. These software instances are to be considered only exemplary indications of how the software could be installed in server 103 and how it could work in conjunction with ESP 102, personal information managers (PIMs, not shown), and main data repository 104. System 102 connects via Internet 101 to system users 106a-n and suppliers 107a-n. It is clear that these connections could also be through direct connection, through a phone system, or through any other suitable networking method, known or to be invented.

FIG. 2 shows an exemplary overview of a calendar system 200, such as would reside in a PIM or PIM database of many users 202a-n. Shown in detail is an exemplary agenda U1 of user 1 202a (not shown). Along timeline 201 are meetings and transportation events 203a-n, and the locations and movement paths 204a-n associated with events 203a-n. For example, if a meeting MTG1 occurs, and a car TR1 has been ordered to pick up a person at location 1, it is safe to assume that meeting 1 is at or near location 1. The car is also scheduled to deliver the person to location 2, so it is also safe to assume that meeting 2 takes place at or near location 2. Therefore, path 1 may be derived as the most likely path of transportation between location 1 and location 2. Similarly, a person attends meeting 2 and orders car TR2 for transportation along path 2 to meeting 3 at location 3. Tracking can be based on GPS location, time, schedules, and other factors.

FIG. 3 shows an exemplary calendar system 300 accounting for a variation in actual time of agenda U1 of user 1 202a. Transportation TR1 203b is delayed, and thus meetings and the following portions of transportation events 303a-n and locations and movement paths 304a-n are rescheduled. The delay does not allow the following meetings to occur on time. In this example, even though it would have been possible to reschedule meeting 2 and meeting 3, it happens that meeting 3 is of greater importance and a decision has been made to skip meeting 2 and advance the time of meeting 3 as much as is convenient for the other attendee(s).

In some cases, importance can be derived by comparing the relative position of the person(s) to be met in the other company, and the size of the business that is done. In other cases, the user defines importance, for example on a 1-3 scale, or a 1-10 scale. Defaulting based on previous meetings may also be offered. In some cases, a post meeting review may rate the meeting and be used for future meetings as a pre-defined default, or adjusted accordingly.

In some cases, attendees will receive along with the schedule change message an option to vote their preference or decline alternatives, which may or may not be considered.

Tracking software module 305 has observed that transportation TR1 203b did not progress along path 1 from location 1 to location 2 according to schedule using a GPS function of a smart phone device, as is described below in relation to the description of FIG. 4. Module 305 has accordingly initiated communication with the user. As a result the decision was made by either the user or the system based on predefined rules and preferences to cancel meeting 2 and rearrange transportation for meeting 3, and also possibly to rebook meeting.

FIG. 4 shows an exemplary process 400 for tracking and rebooking events according to one embodiment of the present invention. In process 401 the GPS position of the user along the predefined route of the agenda is calculated or determined. The user's GPS position can easily be obtained from any of various newer cell phones, which commonly offer GPS functions. In some cases the GPS data may need to be enabled in the network, so system applications can query the GPS. In other cases, specialized software may be installed in a phone or other GPS device that would allow, for example, only the vendor's software to obtain the tracking data, without broadcasting the data to general phone service providers. In process 402 the current location is compared to the location where the user is supposed to be at the current time and the system estimates the progress of the event, relative to the original agenda. Based on the divergence of the user's actual position from the planned position, and in some cases, factoring in current traffic conditions and other elements affecting progress, the system projects an amount of latency for planned events.

In process 404 the process branches. If the latency is not over a certain limit (no), which may be a predetermined limit or a dynamically calculated limit, the system loops to process 405, where the system waits for a predetermined period of time before continuing back to process 401 to restart. For example, a latency of 15 minutes at a meeting may be acceptable in many cases, so by calculating the current location and the remaining way, you can predict the ETA. Also, traffic condition may be used.

The delay before continuing back to process 401 provides certain granularity to the process, because the system would be over-burdened if it continually processed data on a real-time basis. For example, the system could restart the process every minute, every 5 minutes, every 10 minutes, or after any other suitable period of time. If the latency is over the limit (yes), the system moves to process 406, where it prioritizes meetings based on information obtained from database 104 (e.g., based on predefined rules, historic data and preferences).

Based on the derived priorities, in process 407 the system calculates one or more rescheduling proposals for the user and sends them to the user's communication device 420. This device could receive such a message as an SMS, an IM, an email, as a phone call with a voice interaction system, or by any other suitable means of communication. In some cases, the system could call a designated alternate, if the user does not want to be interrupted or if he is out of reach. In process 408 the user sends a response. If the user does not accept any of the system's proposals (no), the system sends a message in process 409 to other parties, informing them of expected delay times for the next event(s). If the user accepts one of the system's proposals (yes), then in process 410 the system checks arrangements to implement the proposal with other parties 106a-n and suppliers 107a-n as needed and in process 411 it goes about the necessary rebooking, canceling, or modifying services and meetings. For example, in process 410 the system may need to check a flight first, before changing an appointment, etc., in process 411.

Although FIG. 4 shows the confirmation sent to the user in process 410, additional confirmations may also be sent to the user after the system finishes making all arrangements and receiving confirmations from all other parties 106a-n and 107a-n. The system then continues to track the progress of the revised agenda, looping back through the process and making further adjustments if necessary. Although this example shows the delay being caused by transportation problems, it is clear that delays may be caused by any of a wide variety of factors, such as extended meeting times or delays by the user in starting out on the agenda (getting a late start). However, the principles and the proposed automatic rearrangements of schedules are the same in all cases.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

It is clear that many modifications and variations of this embodiment may be made by one skilled in the art without departing from the spirit of the novel art of this disclosure. These modifications and variations do not depart from the broader spirit and scope of the invention, and the examples cited here are to be regarded in an illustrative rather than a restrictive sense.

What is claimed is:

1. A computer-implemented method comprising:
identifying a schedule of events for a first user, the schedule of events comprising of one or more of appointments and travel arrangements;
identifying a current location of the first user relative to a scheduled location of the first user based on the schedule of events;
in response to a divergence between a current location and a scheduled location, projecting a latency for one or more remaining scheduled events; and
in response to the projected latency meeting or exceeding an identified amount, identifying priorities among remaining scheduled events and rescheduling one or more remaining scheduled events based on the identified priorities.

2. The computer-implemented method of claim 1, wherein identifying a current location comprises using a global positioning system (GPS) in communication with a portable electronic device.

3. The computer-implemented method of claim 1, wherein the projecting the latency for one or more remaining scheduled events is further based on current traffic conditions along an identified transportation path of a travel arrangement included in the first user's schedule of events.

4. The computer-implemented method of claim 1, wherein the identified amount of latency is dynamically determined.

5. The computer-implemented method of claim 1, further comprising generating a proposed rescheduling of one or more remaining scheduled events based on the identified priorities and communicating the proposed rescheduling to the first user.

6. The computer-implemented method of claim 5, further comprising in response to receiving a rejection of the proposed rescheduling of one or more remaining scheduled events, communicating a message to one or more additional users, the message identifying an expected delay of the first user.

7. The computer-implemented method of claim 5, wherein the rescheduling one or more remaining scheduled events based on the identified priorities further comprises rescheduling the one or more remaining scheduled events based on one or more scheduled events for one or more invitees of appointments for the first user.

8. A machine-readable medium having stored thereon a set of instructions which when executed perform a method comprising:
identifying a schedule of events for a first user, the schedule of events comprising of one or more of appointments and travel arrangements;
identifying a current location of the first user relative to a scheduled location of the first user based on the schedule of events;
in response to a divergence between a current location and a scheduled location, projecting a latency for one or more remaining scheduled events; and
in response to the projected latency meeting or exceeding an identified amount, identifying priorities among remaining scheduled events and rescheduling one or more remaining scheduled events based on the identified priorities.

9. The machine-readable medium of claim 8, wherein identifying a current location comprises using a global positioning system (GPS) in communication with a portable electronic device.

10. The machine-readable medium of claim 8, wherein the projecting the latency for one or more remaining scheduled events is further based on current traffic conditions along an identified transportation path of a travel arrangement included in the first user's schedule of events.

11. The machine-readable medium of claim 8, wherein the identified amount of latency is dynamically determined.

12. The machine-readable medium of claim 8, further comprising generating a proposed rescheduling of one or more remaining scheduled events based on the identified priorities and communicating the proposed rescheduling to the first user.

13. The machine-readable medium of claim 12, further comprising in response to receiving a rejection of the proposed rescheduling of one or more remaining scheduled events, communicating a message to one or more additional users, the message identifying an expected delay of the first user.

14. The machine-readable medium of claim 12, wherein the rescheduling one or more remaining scheduled events based on the identified priorities further comprises rescheduling the one or more remaining scheduled events based on one or more scheduled events for one or more invitees of appointments for the first user.

15. A system comprising:
a means for identifying a schedule of events for a first user, the schedule of events comprising of one or more of appointments and travel arrangements;
a means for identifying a current location of the first user relative to a scheduled location of the first user based on the schedule of events;
a means for projecting a latency for one or more remaining scheduled events, in response to a divergence between a current location and a scheduled location; and
a means for identifying priorities among remaining scheduled events and rescheduling one or more remaining scheduled events based on the identified priorities, in response to the projected latency meeting or exceeding an identified amount.

16. The system of claim 15, wherein the means for identifying a current location comprises a means for using a global positioning system (GPS) in communication with a portable electronic device.

17. The system of claim 15, wherein the means for projecting the latency for one or more remaining scheduled events is based on current traffic conditions along an identified transportation path of a travel arrangement included in the first user's schedule of events.

18. The system of claim 15, wherein the identified amount of latency is dynamically determined.

19. The system of claim 15, further comprising a means for generating a proposed rescheduling of one or more remaining scheduled events based on the identified priorities and communicating the proposed rescheduling to the first user.

20. The system of claim 19, further comprising a means for communicating a message to one or more additional users, in response to receiving a rejection of the proposed rescheduling of one or more remaining scheduled events, the message identifying an expected delay of the first user.
